(19) United States
(12) Patent Application Publication
(10) Pub. No.: US 2014/0193056 A1
(43) Pub. Date: Jul. 10, 2014

(54) Systems and Methods for Patient Anatomical Image Volume Data Visualization Using A Portable Processing Device

(71) Applicant: Siemens Medical Solutions USA, Inc., Malvern, PA (US)

(72) Inventor: Robert A. Neff, Villanova, PA (US)

(73) Assignee: Siemens Medical Solutions USA, Inc., Malvern, PA (US)

(21) Appl. No.: 14/152,012

(22) Filed: Jan. 10, 2014

Related U.S. Application Data
(60) Provisional application No. 61/750,938, filed on Jan. 10, 2013.

(51) Int. Cl. G06T 19/20; G06T 7/00

(52) U.S. Cl. CPC G06T 19/20; G06T 7/0012
USPC 382/131

(57) ABSTRACT

A method for determining an internal anatomical image associated with a patient includes receiving, by a computer, an image of a portion of a patient surface. The computer identifies an anatomical location corresponding to the portion of the patient surface and an image orientation based on the acquired image. Next, the computer determines a three dimensional image volume dataset of internal patient anatomy below the portion of the patient surface based on the anatomical location and the image orientation. The computer derives two dimensional image data on a plane within the three dimensional image volume dataset and transmits the derived two dimensional image data to a destination.

This application claims priority to U.S. provisional application Ser. No. 61/750,938 filed Jan. 10, 2013 which is incorporated herein by reference in its entirety.

### TECHNICAL FIELD

The present invention relates generally to methods, systems, and apparatuses for presenting medical image volume data on a portable processing device. The technology is particularly well-suited to, but not limited to, presenting data gathered from imaging devices such Magnetic Resonance (MR), Computed Tomography (CT), or Positron Emission Tomography (PET) scanners.

### BACKGROUND

Conventional systems for viewing 3D medical image volume data do not allow a clinician to view the image data in a natural form in the context of the patient him/herself and in association with patient contours. Rather, patient medical image data is typically viewed on a two dimensional (2D) computer screen and is navigated using a computer mouse, keyboard, or touch screen. Conventional techniques provide medical image data divorced from the patient and patient contours which may obscure features, diagnostic characteristics, or relationships of importance. Moreover, conventional techniques for viewing medical image data are often not user friendly and overly cumbersome, especially when navigating three dimensional (3D) image volume data.

### SUMMARY

Embodiments of the present invention address and overcome one or more of the above shortcomings and drawbacks, by providing methods, systems, and apparatuses for presenting 3D medical image data on a processing device in a manner that facilitates easy navigation of the data with respect to a corresponding patient's anatomy. The technology is particularly well-suited to, but not limited to, viewing and navigating data gathered from imaging devices such Magnetic Resonance (MR), Computed Tomography (CT), or Positron Emission Tomography (PET) scanners.

According to some embodiments of the present invention, a method for determining an internal anatomical image associated with a patient includes receiving, by a computer, an image of a portion of a patient surface. The computer identifies an anatomical location corresponding to the portion of the patient surface and an image orientation based on the acquired image. The anatomical location corresponding to the portion may comprise, for example, a field of view of a camera acquiring the image of the portion of a patient surface and may be indicated by coordinates in a coordinate framework. The image orientation may comprise, for example, a three dimensional angular value indicating angular orientation with respect to a reference position. The computer determines a three dimensional image volume dataset of internal patient anatomy below the portion of the patient surface based on the anatomical location and the image orientation. The computer derives two dimensional image data on a plane within the three dimensional image volume dataset and transmits the derived two dimensional image data to a destination.

In some embodiments, the aforementioned method for determining an internal anatomical image associated with a patient may be enhanced and/or refined with additional features. For example, in one embodiment, identifying the anatomical location corresponding to the portion of the patient surface and the image orientation based on the acquired image includes determining a transition in pixel luminance associated with the received image; identifying image object edges corresponding to the portion of a patient surface based on the transition in pixel luminance; and matching the image object edges with predetermined anatomical objects using at least one of a translation, a rotation, and a scaling operation. In some embodiments, the size of the two dimensional image may be determined by first determining a first image size corresponding to the received image and then selecting a second size for the two dimensional image in response to determination of the first size.

In some embodiments, the aforementioned method for determining an internal anatomical image associated with a patient may be enhanced and/or refined with features directed toward determining a depth below the patient surface. For example, a depth of a first point on the plane below a second point on the patient surface may be determined. In some embodiments, the depth of the first point may be adjusted based on vertical movement of a portable processing device acquiring the image of a portion of a patient surface. For example, in one embodiment, the depth of the first point is adjusted in a first vertical direction corresponding to movement of the portable processing device in the first vertical direction and adjusted in a second vertical direction opposite to the first direction corresponding to movement of the portable processing device in the second vertical direction.

According to other embodiments of the present invention, a method for displaying an internal anatomical image associated with a patient includes acquiring, by a computer, an image of a portion of a patient surface using a camera operably coupled to the computer. In one embodiment, the computer is a tablet computer, a smart phone, or a wearable computing device. Next, the computer identifies an anatomical location corresponding to the portion of the patient surface and an image orientation based on the acquired image. In one embodiment, the anatomical location corresponding to the portion comprises a field of view of the camera. The orientation of the image may include, for example, a three dimensional angular indication indicating angular orientation with respect to a reference position. The computer uses the identified anatomical location and the determined orientation to retrieve a three dimensional image volume dataset of internal patient anatomy below the portion of the patient surface. Then, the computer derives a two dimensional image data on a plane within the three dimensional image volume dataset presents an updated image corresponding to the two dimensional image data on a display operably coupled to the computer. In one embodiment, the method further includes combining the two dimensional image data with the acquired image to create the updated image.

In some embodiments, the aforementioned method for displaying an internal anatomical image associated with a patient may be enhanced and/or refined with additional features. For example, in one embodiment, identifying the anatomical location corresponding to the portion of the patient surface and the image orientation based on the acquired image includes determining a transition in pixel luminance associated with the received image, identifying image object edges corresponding to the portion of a patient surface based on the transition in pixel luminance, and matching the image object edges with predetermined anatomical objects using at least one of a translation, a rotation, and a scaling operation. As another example of additional features, in some embodiments, deriving two dimensional image data on the plane within the three dimensional image volume dataset includes determining a depth of a first point on the plane below a second point on the patient surface, receiving an indication of vertical movement of the computer, and adjusting the depth of the first point based on the vertical movement. In one embodiment, the depth of the first point is adjusted in a first vertical direction corresponding to movement of the computer in the first vertical direction and adjusted in a second vertical direction opposite to the first direction corresponding to movement of the computer in the second vertical direction.

According to other embodiments of the present invention, a system for displaying an internal anatomical image associated with a patient includes an interface, an image data processor, and an output processor. The interface is configured to receive an image of a portion of a patient surface. The image data processor is configured to identify an anatomical location corresponding to the portion of the patient surface and an image orientation based on the acquired image, determine a three dimensional image volume dataset of internal patient anatomy below the portion of the patient surface based on the anatomical location and the image orientation, and derive two dimensional image data on a plane within the three dimensional image volume dataset. The output processor configured to transmit the two dimensional image data to a destination.

In some embodiments, the aforementioned system further comprises a software module operating on portable processing device. The software module may be configured to acquire the image of the portion of the patient surface using a camera operably coupled to the portable processing device, transmit the image to the interface, receive the two dimensional image data from the output processor, and present the a combination of the two dimensional image data and the acquired image on a display operably coupled to the portable processing device. In one embodiment, the image data processor is further configured to determine a vertical movement of the portable processing device, adjust a depth associated with the plane within the three dimensional image volume dataset based on the vertical movement, and derive updated two dimensional image data on a plane within the three dimensional image volume dataset based on the adjusted depth.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an illustration of an anatomical imaging system, according to some embodiments of the present invention;

FIG. 2 provides a broad overview of a process for visualizing patient anatomical image volume data using a portable processing device, according to some embodiments of the present invention;

FIG. 3 provides an example process illustrating how 3D image volume data may be superimposed on a live image, according to some embodiments of the present invention;

FIG. 4 provides a series of images illustrating how anatomical images are displayed on the portable device, according to some embodiments of the present invention;

FIG. 5 provides a series of images illustrating how anatomical images are displayed on the portable device with overlaid depth-based images, according to some embodiments of the present invention;

FIG. 6 provides an illustration of the height between the tablet and patient body surface, along with the depth of the field of view inside the 3D volume data, according to some embodiments of the present invention;

FIG. 7 provides an example of the effects of modifying tablet viewing angle, according to some embodiments of the present invention; and

FIG. 8 illustrates an exemplary computing environment within which embodiments of the invention may be implemented.

### DETAILED DESCRIPTION

The following disclosure describes the present invention according to several embodiments directed at methods, systems, and apparatuses for presenting 3D medical image volume data on a portable processing device in a manner that facilitates easy navigation of a patient's anatomy. For example, in some embodiments, the portable device displays an internal anatomical image through a previously captured 3D volume representing the internal anatomy below the identified portion of patient anatomy at a depth within the anatomy determined based on the height of the camera lens above the patient surface. The system, methods, and apparatuses described herein are especially applicable, but not limited to, navigating bodily regions through 3D anatomical image volume data, in a natural manner as an aid in examining a patient and educating personnel concerning patient condition.

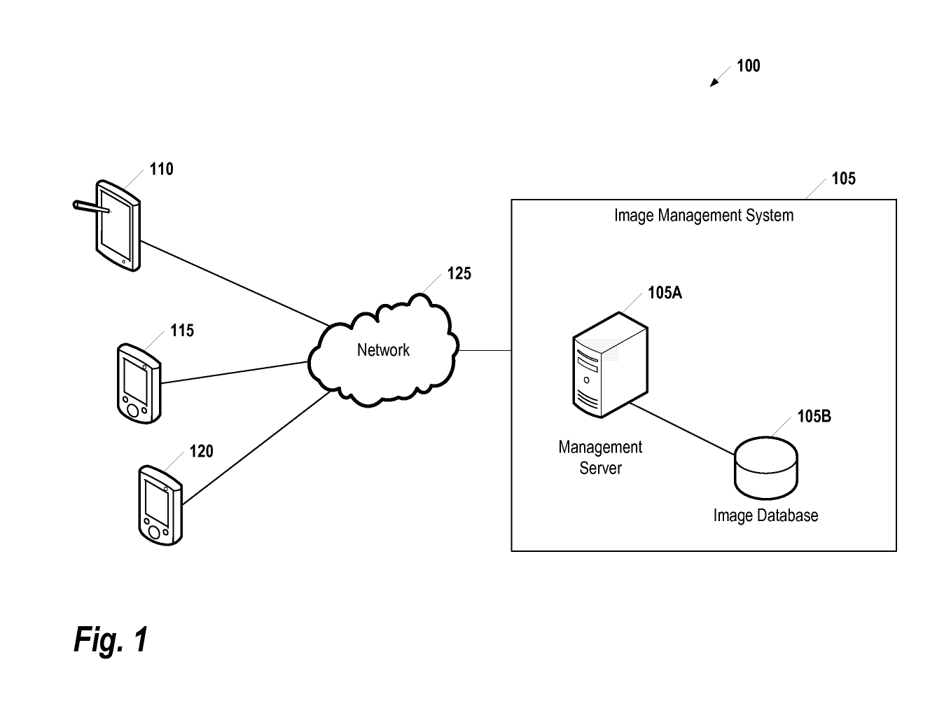

FIG. 1 provides an illustration of an anatomical imaging system 100, according to some embodiments of the present invention. In the example of FIG. 1, devices 110, 115, 120 communicate with image management system 105 over network 125 and present image information on screen included in each respective device. Thus, any device known in the art with a display screen and networking capabilities may be used in the anatomical imaging system described herein. Examples of devices that may be used with the system 100 include without limitation, smart phones, tablet computers, video game devices, wearable electronics such as Google G1ass™, as well as specialized medical devices designed for clinical applications. Additionally, while the examples discussed above and presented in FIG. 1 are wireless devices, wired devices may also be used within the scope of embodiments of the present invention.

The Management Server 105A receives information from the devices 110, 115, 120 and queries the database 105B for imaging data. The Image Database 105B provides imaging data previously acquired, for example, via imaging modalities such as, without limitation, Magnetic Resonance Imaging (MRI), X-ray, Computed Tomography (CT), or Ultrasound. Data in the database 105B may be organized according to patient identification information to facilitate rapid retrieval and processing. For example, in one embodiment, the devices 110, 115, 120 provide position information and a patient identifier to the management server 105A. The patient information may then be used to retrieve a patient record from the database 105B. This patient record may comprise, for example, MR image data. Then, the position information is used to select a particular portion of the image data to send in response to the requesting device.

In FIG. 1, the computer network 125 connecting the devices 110, 115, 120 with the Image Management System 105 may be implemented with a variety of hardware platforms. For example, the computer network 125 may be implemented using the IEEE 802.3 (Ethernet) or IEEE 802.11 (wireless) networking technologies, either separately or in combination. In addition, the computer network 125 may be implemented with a variety of communication tools including, for example, TCP/IP suite of protocols. In some embodiments, the computer network 125 is the Internet. A virtual private network (VPN) may be used to extend a private network across the computer network 125. In some embodiments, the computer network 125 comprises a direct connection between one or more of the devices 110, 115, 120 and the Image Management System 105 implemented using a protocol such as, for example, Universal Serial Bus (USB) or FireWire.

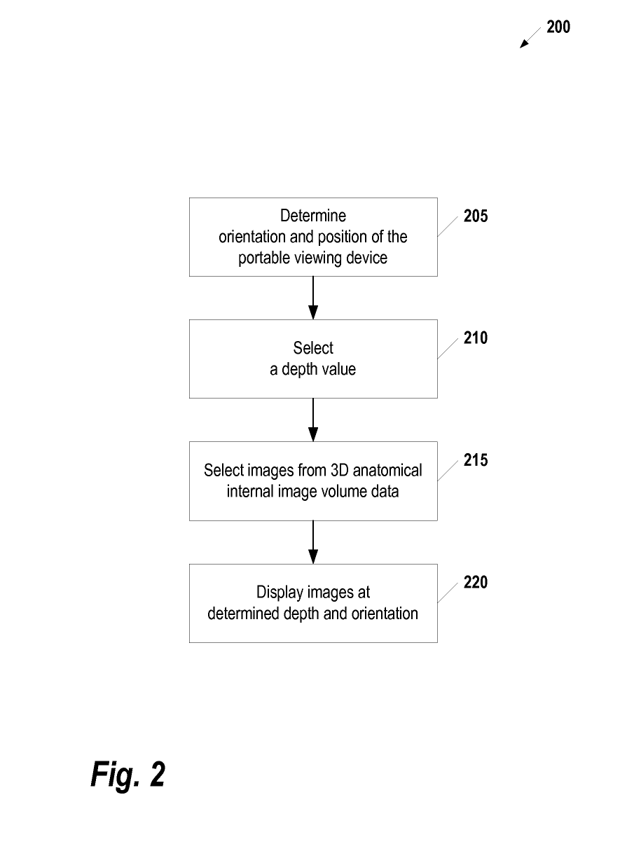

FIG. 2 provides a broad overview of a process 200 for visualizing patient anatomical image volume data using a portable processing device, according to some embodiments of the present invention. The portable viewing device may be, for example, such as, for example, one of devices 110, 115, and 120 in FIG. 1. At 205, the orientation and position (e.g., field of view) of the portable viewing device is determined. For example, in some embodiments, a clinician holds the portable device over the patient. The camera on the portable device continuously acquires live images of a portion of a patient and sends the live image data to a processor (e.g., an image data processor included in anatomical imaging system 100) to identify a location of the portion of the patient shown by the live image of the patient. In some embodiments, the location is identified by determining luminance transitions representing edges of features (e.g. corresponding to anatomy portions, limbs, joints, head chest, abdomen, and/or neck). Then, image object edges corresponding to the portion of a patient surface may be identified based on the transition in pixel luminance. These image object edges may be matched with predetermined anatomical objects, for example, using iterative scaling, translation and/or rotation operations. The location information may identify the position of the image on the patient, as well as the orientation/perspective of the image. For example, if the processor determines that the camera is looking at the foot, it may also determine the perspective and orientation of the foot. The camera may be looking at the top, bottom, side (left or right), or some compound vector including different perspectives.

The location information may be expressed in any format known in the art. For example, in one embodiment, the location is indicated by coordinates in a conventional (e.g., Cartesian) coordinate framework. The orientation information may include, for example, a three dimensional angular value indicating angular orientation with respect to a reference position (e.g., a calibrated position within the patient, a position within the coordinate framework, or an absolute vertical position).

In some embodiments, position and/or orientation may be continuously updated as the user moves the device. For example, in one embodiment, shape detection is used to determine the initial position of the camera. This initial position may be determined by positioning the portable device at a sufficiently wide angle such that the field of view presented on the device includes well-defined bodily features. Following recognition of the initial position, once the device is moved, an updated position may be calculated, for example, by tracking the percentage of image movement on the screen. In some embodiments, accelerometers may be additionally (or alternatively) used to determine the distance movement and also the angle movement of the portable device. The position and orientation may be continuously updated with respect to the initial position using, for example, accelerometer data, visual positioning, and/or orientation data determined from anatomical feature recognition.

Continuing with reference to FIG. 2, at 210, a user may select and adjust the depth of the 3D volume anatomical data which will be displayed, thus giving the clinician the effect of seeing deeper into the patient body. The depth may be initially set through a default configuration setting on the portable device. Then, as the portable device moves closer or farther away from the patient (e.g., as determined by image analysis of the live capture image or a separate infra-red depth sensor) the depth of the internal anatomy image through the 3D volume may be correspondingly varied. In one embodiment, the portable viewing device includes a depth set button which, upon activation by a user, selects a default depth (e.g., halfway through the 3D volume depth as corresponding to a current camera lens height above the patient surface). This depth can be further adjusted, for example, through further interaction with the depth set button or with another component such as a graphical slider presented on the display.

Returning to FIG. 2, at 215, the orientation, position, and depth value is used select one or more images from 3D anatomical internal image volume data. The internal 3D internal anatomical volume data may comprise one or more of, static image data, moving video data (e.g. MPEG compatible), and sound data. The 3D volume data may be acquired by an imaging or sound recording system and rendered into a 3D volume representing the patient from different angles and viewpoint, including inside the patient. In some embodiments, the selected images are previously acquired and stored in a database for later reference and use. In other embodiments, the data may be captured in real-time, for example, using an imaging device such as a C-arm CT machine. It should be noted that steps 205, 210, and 215 of the process 200 may be performed by the portable viewing device and/or the anatomical imaging system 105. For example, in some embodiments, the portable viewing device collects raw data which is transmitted to the image management system 105 for determination of the various values required to select the images from image volume data.

At 220 in FIG. 2, the portable viewing device displays the selected images at the determined depth and orientation through the 3D volume data at the corresponding correct position. In cases where there is live (i.e., current) data being collected (e.g., sounds and/or images), this data may be superimposed onto other displayed image data. As the portable device is moved, an updated position and orientation and camera field of view is determined and the corresponding 3D internal anatomy image volume data is rendered and displayed, or superimposed on the live image displayed on the device. The 3D image volume data may be rendered using any rendering method known in the art. In some embodiments, a plane in 3D space is calculated at the determined depth, representing the plane of the image currently being gathered from the patient. The corresponding plane may be calculated within the 3D image volume data and the image representing the 2D view of that plane is displayed to the user. In some embodiments, this plane may be adjusted based on movement of the device in a vertical direction. For example, vertical movement of the device may be used to determine a new depth and, in turn, select a new plane from the 3D image volume. In some embodiments, sound data is presented on the portable viewing device in addition to, or as an alternative to, the imaging data. For example, in one embodiment, as the portable device gets closer to the heart, a heartbeat sound being played over the speakers of the portable device gets louder.

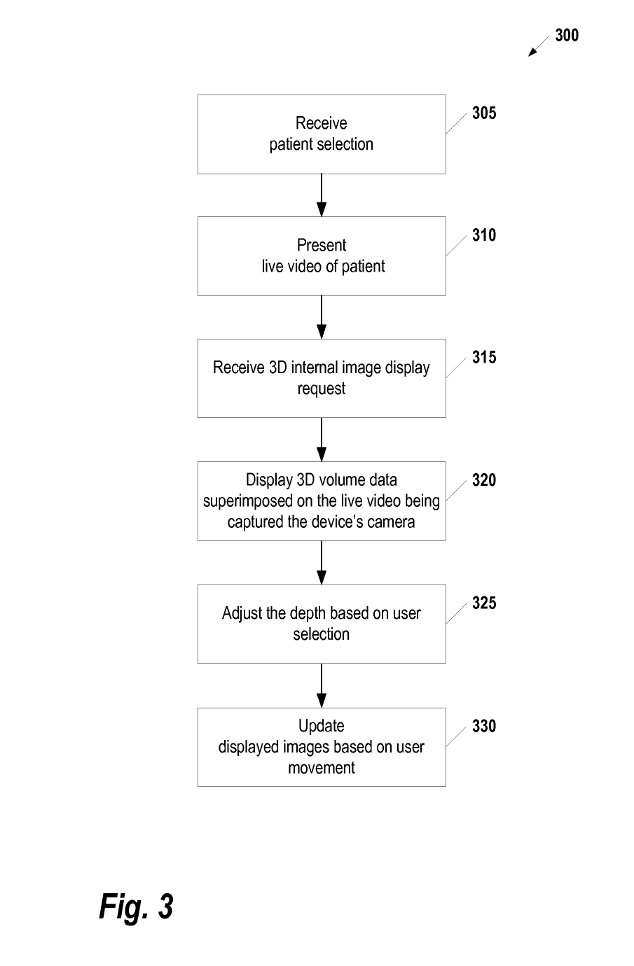

FIG. 3 provides an example process 300 illustrating how 3D image volume data may be superimposed on a live image, according to some embodiments of the present invention. At 305, the portable device receives a selection of a patient. This selection may be performed, for example, by entering a patient identifier (e.g., name or patient number) or by selecting the patient identifier from a list of available patient identifiers. In response, at 310, the portable device presents a live video of the patient on the portable device's screen. In some embodiments, the live video is captured using a camera included in the portable device. In other embodiments, the live video is streamed from an external camera over a network for display on the portable device. Next, at 315, the portable device receives a request to display a 3D internal anatomical image volume image for display or overlay on the portable device screen. Then, at 320, the portable device displays the 3D volume data superimposed on the live video being displayed on the portable device. In some embodiments, the actual current video image can be adjusted to be faded (anywhere from 0% to 100% [completely invisible]). At 325, the user of the portable device adjusts the depth of the 3D volume data being displayed by either moving the tablet in a direction (e.g., forward and/or closer to the patient) or by selecting a depth setting on the device. Then, at 330, the display updates the 3D image volume data being superimposed on the video image based on the adjustments made at 325.

In one embodiment, to determine the position of the camera shape detection is used. The portable device position starts from a position where enough of the patient is visible in the image to determine the location. For example, this position may be where the image is of a sufficiently wide angle to show feature edges of the body such that the location (e.g., field of view) may be determined on the patient body surface. Following recognition of an initial position, in response to a new camera image being determined at a new position, the corresponding new position location is calculated by tracking a percentage of image movement across a screen, for example. Accelerometers may also be used to determine the distance movement and also the angle movement of the portable device. The position and orientation may be continuously updated with respect to a starting point using, for example, accelerometer data, visual positioning, and/or orientation data determined from anatomical feature recognition.

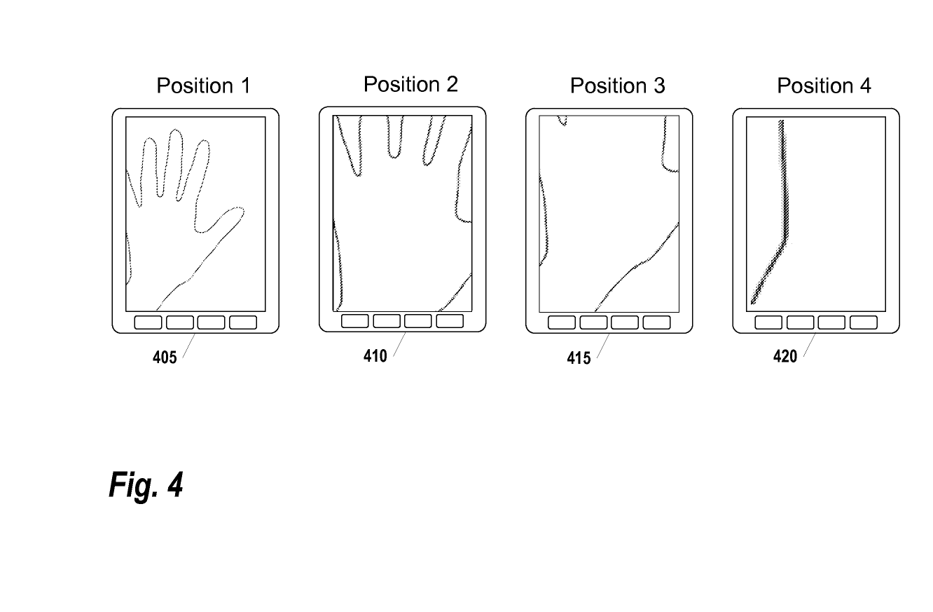

FIG. 4 provides a series of images illustrating how anatomical images are displayed on the portable device, according to some embodiments of the present invention. In FIG. 4, a first image 405 (Position 1) shows an initial camera field of view with body position and image orientation determined by feature (i.e., hand) recognition. As the user moves the camera from first position 405 to a second position 410, a processor may be used to track the movement and calculate a new position. In the example of FIG. 4, the second image 410 presents a zoomed-in representation of the first image 405. To properly fit the field of view, the processor may calculate an image size and/or a percentage of zoom corresponding to the first image which, in turn, may be used to determine the new image size. As the camera moves from the second position 410 to the third position 415, the processor updates the location based on the known position for second position 410. The fourth position 420 shows a highly zoomed-in image which may be navigated to from the third position 415. The fourth position 420 may be determined, for example, using image and accelerometer tracking. It should be noted that, for some applications, the fourth position 420 overly magnifies the image, such that it is not a desirable starting point since it does not have enough context and perspective for the system to determine body features and identify the part of the body concerned.

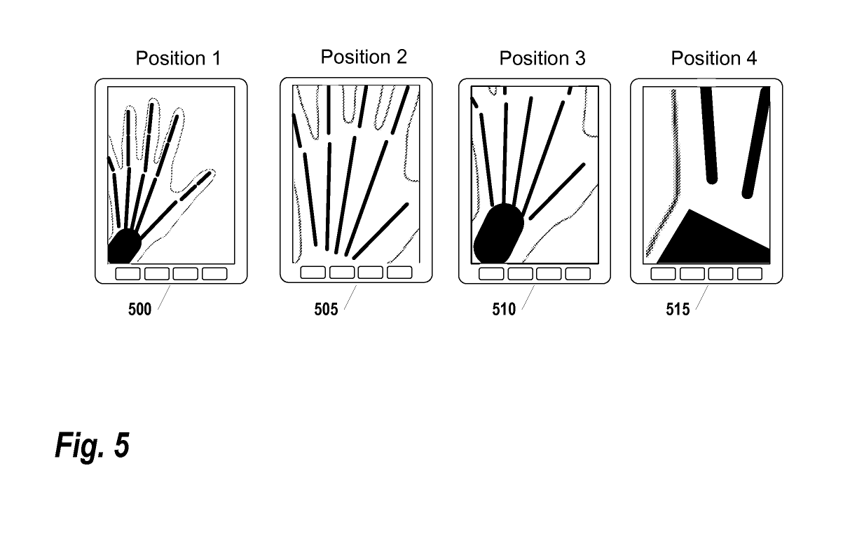

FIG. 5 provides a series of images 500, 505, 510, 515 illustrating how anatomical images are displayed on the portable device with overlaid depth-based images, according to some embodiments of the present invention. Such overlaying may be used, for example, to present an image of a particular portion or orientation at a muscle-level, a bone-level, and/or an intermediary level. In one embodiment, a depth dial or slider is provided (e.g., on the device or on the image itself) to enable the depth to be changed manually by the user. In other embodiments, vertically moving the device closer or further from the patient adjusts the depth of the 3D volume data displayed. A user selectable setting may be used to switch between depth control and general zooming in and out as the device moves closer or further from the patient. In some embodiments, to determine depth distance, the portable device tracks the percentage of increase in image size as the tablet moves closer or further from the patient and calibrates a depth adjustment based on a percentage times a multiplier. The system may utilize image stabilization processing to trim out shaking of user hands and minor movements of a patient body.

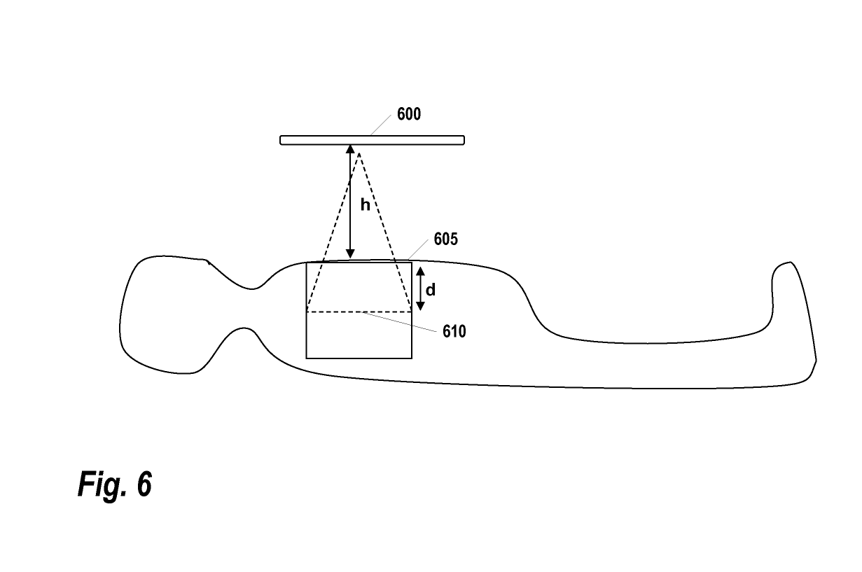

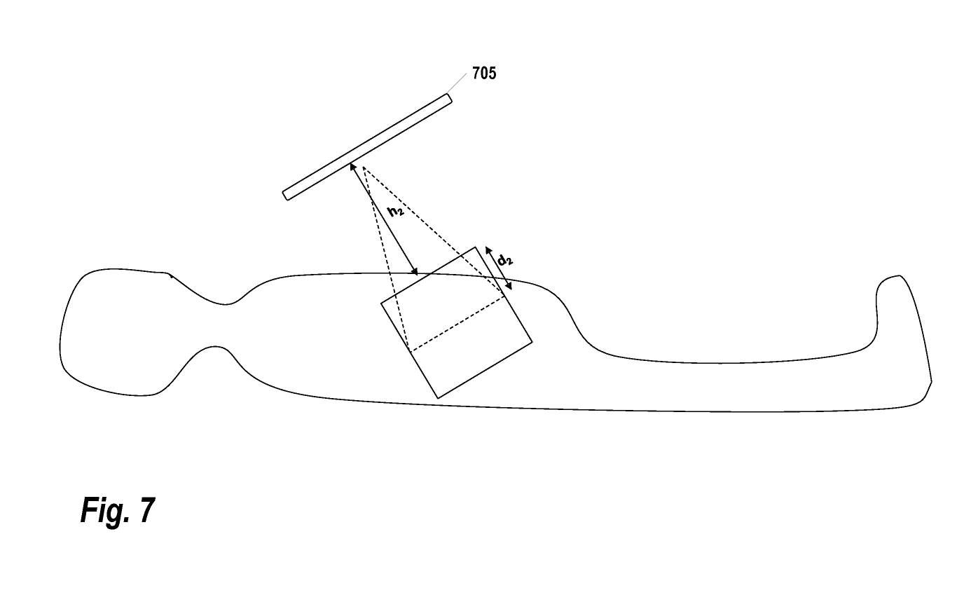

FIG. 6 provides an illustration of the height (h) between the tablet 600 and patient body surface 605, along with the depth of the field of view inside the 3D volume data, according to some embodiments of the present invention. In one embodiment the default depth starts at the center 605 of the volume data (e.g., half of the total depth of the volume), however the viewed depth is adjusted while holding the tablet still and manipulating a setting on the tablet or otherwise by physically moving the tablet closer or father away (i.e., changing the height (h)). FIG. 7 provides an example of what happens when the tablet angle is changed, according to some embodiments of the present invention. The new height (h₂) is changed as well as the depth (d₂). The viewable field is on an angle equal to that of the angle of the tablet 705.

It should be noted that the techniques described FIGS. 2-7 are example implementations of embodiments of the present invention. However, various features of these embodiments may be performed solely by the portable processing device, solely by a remote computer (e.g., Image Management System 105), or by a combination of the portable processing device and remote computer. In some embodiments, a remote computer receives an image of a portion of a patient surface captured by the device and transmits two dimension image data (e.g., a displayable image) in return. For example, the remote computer may identify an anatomical location corresponding to the portion of the patient surface and an image orientation based on the acquired image, determine a three dimensional image volume dataset of internal patient anatomy below the portion of the patient surface based on the anatomical location and the image orientation, and derive the two dimensional image data from a plane within the three dimensional image volume dataset. In other embodiments, the portable processing device (e.g., using a software module such as a smart phone app) identifies an anatomical location corresponding to the portion of the patient surface and an image orientation based on the acquired image. Then, it uses the identified anatomical location and the determined orientation to retrieve a three dimensional image volume dataset of internal patient from the remote computer which, in turn, the device may use to derive a two dimensional image data on a plane within the three dimensional image volume dataset. The device may then present an updated image corresponding to the two dimensional image data on a display operably coupled to the portable processing device.

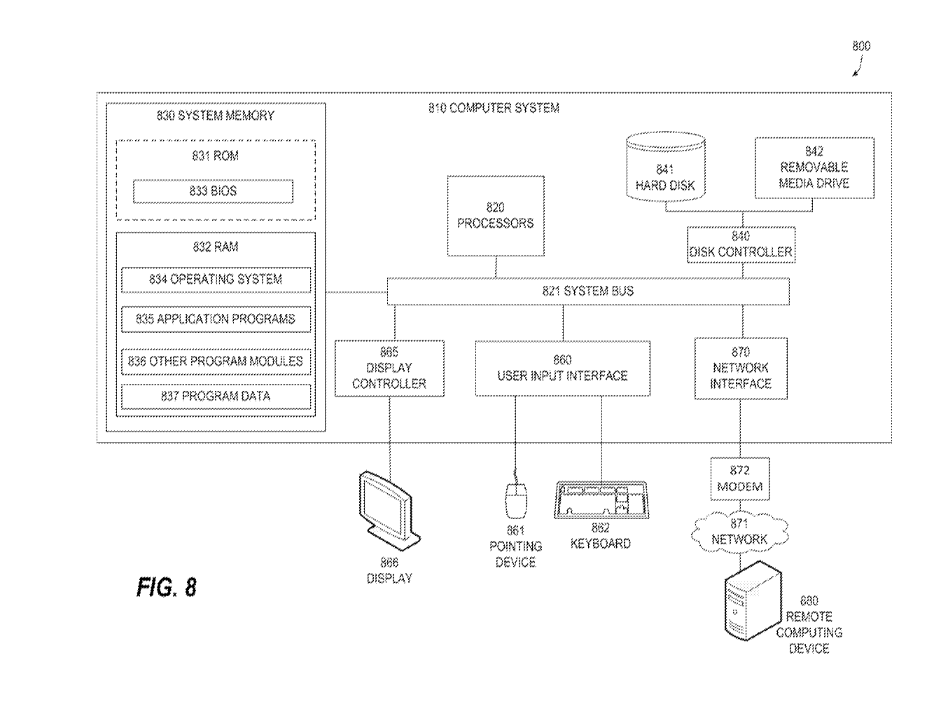

FIG. 8 illustrates an exemplary computing environment 800 within which embodiments of the invention may be implemented. This environment 800 may be used, for example, to implement a portion of one or more components of Image Management System 105 illustrated in FIG. 1. Computing environment 800 may include computer system 810, which is one example of a computing system upon which embodiments of the invention may be implemented. Computers and computing environments, such as computer system 810 and computing environment 800, are known to those of skill in the art and thus are described briefly here.

As shown in FIG. 8, the computer system 810 may include a communication mechanism such as a bus 821 or other communication mechanism for communicating information within the computer system 810. The system 810 further includes one or more processors 820 coupled with the bus 821 for processing the information.

The processors 820 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 8, the computer system 810 also includes a system memory 830 coupled to the bus 821 for storing information and instructions to be executed by processors 820. The system memory 830 may include computer readable storage media in the form of volatile and/or nonvolatile memory, such as read only memory (ROM) 831 and/or random access memory (RAM) 832. The system memory RAM 832 may include other dynamic storage device(s) (e.g., dynamic RAM, static RAM, and synchronous DRAM). The system memory ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in ROM 831. RAM 832 may contain data and/or program modules that are immediately accessible to and/or presently being operated on by the processors 820. System memory 830 may additionally include, for example, operating system 834, application programs 835, other program modules 836 and program data 837.

The computer system 810 also includes a disk controller 840 coupled to the bus 821 to control one or more storage devices for storing information and instructions, such as a magnetic hard disk 841 and a removable media drive 842 (e.g., floppy disk drive, compact disc drive, tape drive, and/or solid state drive). The storage devices may be added to the computer system 810 using an appropriate device interface (e.g., a small computer system interface (SCSI), integrated device electronics (IDE), Universal Serial Bus (USB), or FireWire).

The computer system 810 may also include a display controller 865 coupled to the bus 821 to control a display or monitor 865, such as a cathode ray tube (CRT) or liquid crystal display (LCD), for displaying information to a computer user. The computer system includes an input interface 860 and one or more input devices, such as a keyboard 861 and a pointing device 862, for interacting with a computer user and providing information to the processor 820. The pointing device 862, for example, may be a mouse, a light pen, a trackball, or a pointing stick for communicating direction information and command selections to the processor 820 and for controlling cursor movement on the display 866. The display 866 may provide a touch screen interface which allows input to supplement or replace the communication of direction information and command selections by the pointing device 861.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as a hard disk 841 or a removable media drive 842. The hard disk 841 may contain one or more datastores and data files used by embodiments of the present invention. Datastore contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according embodiments of the invention and for containing data structures, tables, records, or other data described herein. The term “computer readable medium” as used herein refers to any medium that participates in providing instructions to the processor 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as hard disk 841 or removable media drive 842. Non-limiting examples of volatile media include dynamic memory, such as system memory 830. Non-limiting examples of transmission media include coaxial cables, copper wire, and fiber optics, including the wires that make up the bus 821. Transmission media may also take the form of acoustic or light waves, such as those generated during radio wave and infrared data communications.

The computing environment 800 may further include the computer system 820 operating in a networked environment using logical connections to one or more remote computers, such as remote computer 880. Remote computer 880 may be a personal computer (laptop or desktop), a mobile device, a server, a router, a network PC, a peer device or other common network node, and typically includes many or all of the elements described above relative to computer 810. When used in a networking environment, computer 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing system 880). The network 871 may be wired, wireless or a combination thereof. Wired connections may be implemented using Ethernet, Universal Serial Bus (USB), RJ-11, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the UI display images in response to signals received from the input devices. In this way, the user may interact with the display image using the input devices, enabling user interaction with the processor or other device.

The functions and process steps herein may be performed automatically or wholly or partially in response to user command An activity (including a step) performed automatically is performed in response to one or more executable instructions or device operation without user direct initiation of the activity.

The embodiments of the present invention can be included in an article of manufacture comprising, for example, a non-transitory computer readable medium. This computer readable medium may have embodied therein a method for facilitating one or more of the techniques utilized by some embodiments of the present invention. The article of manufacture may be included as part of a computer system or sold separately.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A method for determining an internal anatomical image associated with a patient, comprising:
receiving, by a computer, an image of a portion of a patient surface;
identifying, by the computer, an anatomical location corresponding to the portion of the patient surface and an image orientation based on the acquired image;
determining by the computer, a three dimensional image volume dataset of internal patient anatomy below the portion of the patient surface based on the anatomical location and the image orientation;
deriving, by the computer, two dimensional image data on a plane within the three dimensional image volume dataset; and
transmitting, by the computer, the two dimensional image data to a destination.

2. The method of claim 1, wherein identifying the anatomical location corresponding to the portion of the patient surface and the image orientation based on the acquired image comprises:
determining a transition in pixel luminance associated with the received image;
identifying image object edges corresponding to the portion of a patient surface based on the transition in pixel luminance; and
matching the image object edges with predetermined anatomical objects using at least one of a translation, a rotation, and a scaling operation.

3. The method of claim 1, further comprising:
determining a first image size corresponding to the received image; and
selecting a second size for the two dimensional image in response to determination of the first size.

4. The method of claim 1, wherein deriving two dimensional image data on the plane within the three dimensional image volume dataset comprises:
determining a depth of a first point on the plane below a second point on the patient surface.

5. The method of claim 4, further comprising:
adjusting the depth of the first point based on vertical movement of a portable processing device acquiring the image of a portion of a patient surface.

6. The method of claim 5, wherein the depth of the first point is adjusted in a first vertical direction corresponding to movement of the portable processing device in the first vertical direction and adjusted in a second vertical direction opposite to the first direction corresponding to movement of the portable processing device in the second vertical direction.

7. The method of claim 1, wherein the anatomical location corresponding to the portion comprises a field of view of a camera acquiring the image of the portion of a patient surface.

8. The method of claim 1, wherein the anatomical location is indicated by coordinates in a coordinate framework.

9. The method of claim 1, wherein the image orientation comprises a three dimensional angular value indicating angular orientation with respect to a reference position.

10. A method for displaying an internal anatomical image associated with a patient, comprising:
acquiring, by a computer, an image of a portion of a patient surface using a camera operably coupled to the computer;
identifying, by the computer, an anatomical location corresponding to the portion of the patient surface and an image orientation based on the acquired image;
using, by the computer, the identified anatomical location and the determined orientation to retrieve a three dimensional image volume dataset of internal patient anatomy below the portion of the patient surface;
deriving, by the computer, a two dimensional image data on a plane within the three dimensional image volume dataset; and
presenting, by the computer, an updated image corresponding to the two dimensional image data on a display operably coupled to the computer.

11. The method of claim 10, wherein identifying the anatomical location corresponding to the portion of the patient surface and the image orientation based on the acquired image comprises:
determining a transition in pixel luminance associated with the received image;
identifying image object edges corresponding to the portion of a patient surface based on the transition in pixel luminance; and
matching the image object edges with predetermined anatomical objects using at least one of a translation, a rotation, and a scaling operation.

12. The method of claim 10, wherein deriving two dimensional image data on the plane within the three dimensional image volume dataset comprises:
determining a depth of a first point on the plane below a second point on the patient surface;
receiving an indication of vertical movement of the computer; and
adjusting the depth of the first point based on the vertical movement.

13. The method of claim 12, wherein the depth of the first point is adjusted in a first vertical direction corresponding to movement of the computer in the first vertical direction and adjusted in a second vertical direction opposite to the first direction corresponding to movement of the computer in the second vertical direction.

14. The method of claim 10, wherein the computer is a tablet computer, a smart phone, or a wearable computing device.

15. The method of claim 10, wherein the anatomical location corresponding to the portion comprises a field of view of the camera.

16. The method of claim 10, the orientation of the image comprises a three dimensional angular indication indicating angular orientation with respect to a reference position.

17. The method of claim 10, further comprising:
combining the two dimensional image data with the acquired image to create the updated image.

18. A system for displaying an internal anatomical image associated with a patient, comprising:
an interface configured to receive an image of a portion of a patient surface;
an image data processor configured to:
identify an anatomical location corresponding to the portion of the patient surface and an image orientation based on the acquired image,
determine a three dimensional image volume dataset of internal patient anatomy below the portion of the patient surface based on the anatomical location and the image orientation, and
derive two dimensional image data on a plane within the three dimensional image volume dataset; and
an output processor configured to transmit the two dimensional image data to a destination.

19. The system of claim 18, wherein the system further comprises a software module operating on portable processing device, the software module configured to:
acquire the image of the portion of the patient surface using a camera operably coupled to the portable processing device;
transmit the image to the interface;
receive the two dimensional image data from the output processor; and
present a combination of the two dimensional image data and the acquired image on a display operably coupled to the portable processing device;

20. The system of claim 19, wherein the image data processor is further configured to:
determine a vertical movement of the portable processing device;
adjust a depth associated with the plane within the three dimensional image volume dataset based on the vertical movement; and
derive updated two dimensional image data on a plane within the three dimensional image volume dataset based on the adjusted depth.
